(19) United States
(12) Patent Application Publication
(10) Pub. No.: US 2025/0148853 A1
(43) Pub. Date: May 8, 2025

(54) METHOD AND SYSTEM FOR THE AUTHENTICATION OF HOLOGRAM PROTECTED IDENTITY DOCUMENTS

(71) Applicant: IMDS GROUP INC., Montreal (CA)

(72) Inventors: Nicole VINCENT, Paris (FR); Camille KURTZ, Suresnes (FR); Oumayma KADA, Montreuil (FR); Cuong VAN KIEU, Montreal (CA)

(21) Appl. No.: 18/833,749

(22) PCT Filed: Jan. 28, 2023
(86) PCT No.: PCT/CA2023/050120

§ 371 Date: Jul. 26, 2024

Related U.S. Application Data
(60) Provisional application No. 63/304,608, filed on Jan. 29, 2022.

(51) Int. Cl. G07D 7/12; B42D 25/24; B42D 25/328; G06V 10/56

(52) U.S. Cl. CPC G07D 7/12; B42D 25/24; B42D 25/328; G06V 10/56

(57) ABSTRACT

A method and system for the authentication of hologram protected identity documents using, for example, a video obtained from a smartphone or tablet in natural light conditions, indoor or outdoor. From a first selection of pixels in frames of the video, based on pixel properties such as saturation and value, the shape of connected components and hues of the selected pixels are studied in order to detect the presence of a hologram. Furthermore, the hologram can be retrieved by an aggregation of image parts extracted from each of the frames.

### CROSS-REFERENCE TO RELATED APPLICATIONS

This application claims the benefits of U.S. provisional patent application No. 63/304,608 filed on Jan. 29, 2022, which is herein incorporated by reference.

### TECHNICAL FIELD

The present disclosure relates to a method and system for the authentication of hologram protected identity (ID) documents.

### BACKGROUND

The ways by which information is shared are constantly evolving. People exchange information via the Internet using text or speech, but they also share certain documents. Accordingly, it is more and more important to be able to verify one's identity through the Internet. The identity of a person is supposed to be validated using an identity (ID) document, for example a passport. Through the Internet only a photo of the ID document, conveyed as a digital image, can be exchanged. Consequently, the problem of person authentication has evolved and not only the person has to be identified but also their ID document must be authenticated using its digital image to detect falsified documents. The ID documents are designed so that they are difficult to forge. Some security elements are added and/or hidden in the background of the ID documents information, within the paper and the ink. Other security elements in the form of Radio Frequency Identification (RFID) tags added to the document, or holograms. Among the added security elements, some can be verified remotely while others cannot.

Accordingly, there is a need for a method and system for the authentication of hologram ID documents.

### SUMMARY

The present disclosure provides a method and system for the authentication of a hologram protected document, comprising the steps of:
a) obtaining at least two images of the document;
b) identifying in each of the at least two images pixels having a saturation and a value above respective saturation and value threshold;
c) building a set of identified pixels connected components from the identified pixels of step b) for each of the least two images;
d) removing from the set of identified pixels connected components any connected components belonging to a porous structure;
e) computing a number of hues present in each remaining connected component of the set of identified pixels connected components and normalizing the number of hues according to a size of each of the remaining connected component from the set of identified pixels connected components;
f) removing from the remaining connected components of the set of identified pixels connected components any connected component associated with a normalized number of hues below a specified hue number value;
g) determining the presence of a hologram by computing a difference between color features of the remaining connected components of the set of identified pixels connected components of different images of the at least two images;
h) setting a document score by computing an average of all the computed differences;
i) authenticating the hologram protected document when the document score is above a specified document score value.

There is also provided a method and system for the authentication of a hologram protected document wherein the document is an identity document, for example a passport or a consular card.

There is further provided a method and system for the authentication of a hologram protected document wherein the saturation threshold and the value threshold are determined from respective saturation and value histograms, for example by choosing a significant minimum higher than the mean value of the corresponding saturation and value histograms.

There is further still provided a method and system for the authentication of a hologram protected document wherein step a) includes expressing the at least two images in the HSV colors space.

There is also provided a method and system for the authentication of a hologram protected document wherein step d) includes for each of the at least two images:
obtaining a dilated set of connected components by applying dilation to the set of identified pixels connected components;
each time a number of connected components of the set of identified pixels connected components present in a given connected component of the dilated set of connected components is above a specified connection number value, removing pixels of the given connected component of the dilated set of connected components from the set of identified pixels connected components.

There is further provided a method and system for the authentication of a hologram protected document wherein the specified connection number value at step d), the specified hue number value at step f) and the specified document score value at step i) are determined using a set of training images.

There is further still provided a method and system for the authentication of a hologram protected document wherein at step a) the at least two images are obtained by extracting frames from a video of the document.

There is also provided a method and system for the authentication of a hologram protected document wherein step g) if performed for all pairs of consecutive frames or for pairs of distant frames of the video.

There is further provided a method and system for the authentication of a hologram protected document further comprising the step of:
j) recovering the hologram by aggregating pixels of the remaining connected components of the set of identified pixels connected components of each of the at least two images to which is applied an associated frame transform.

There is further still provided a method and system for the authentication of a hologram protected document wherein a step j) the associated frame transform is a transform of a video frame corresponding to each of the at least two images during fixed frame registration.

There is also provided a method and system for the authentication of a hologram protected document wherein the steps are in the form of executable code for execution by a processor of a smartphone or tablet.

### BRIEF DESCRIPTION OF THE FIGURES

Embodiments of the disclosure will be described by way of examples only with reference to the accompanying drawings, in which:

FIG. 1 is an image of an example of a French passport where a part of a security element in the form of a hologram is visible;

FIG. 2 is an image of parts of a hologram with flashy colors;

FIG. 3 is an example of a saturation histogram HS and a value histogram HV for an image including a hologram, the respective TS and TV vertical lines materializing the ideal value of a threshold in order to select the hologram pixels;

FIG. 4 is an example of a saturation histogram C with the position of the threshold defining a constraint for hologram pixels;

FIG. 5 is an image of a hologram part detected in an image where a display device can be seen in the top part of the image, where only the edges of the screen are selected;

FIG. 6 is an image of non-hologram pixels associated with a glint in the initial image, the selected pixels having a porous structure figured by small neighboring components;

FIGS. 7A and 7B are an image I without any hologram (FIG. 7A) and a zoom on a part of H(I) associated with the white part on the right part of I (FIG. 7B);

FIGS. 8A, 8B and 8C are images of three extractions of pixels of a potential hologram in consecutive frames of a video at frames (i) (FIG. 8A), (i+1) (FIG. 8B) and (i+2) (FIG. 8C);

FIGS. 9A and 9B are images of extraction of histogram pixels from a French passport (FIG. 9A) and a Canadian passport (FIG. 9B) through video acquisitions;

FIGS. 10A and 10B are images of two examples of fake identity documents (without hologram);

FIG. 11 is a schematic representation of the system for the authentication of hologram protected ID documents in accordance with an illustrative embodiment of the present disclosure; and

FIG. 12 is a flow diagram depicting the method for the authentication of hologram protected ID documents in accordance with the illustrative embodiment of the present disclosure.

Similar references used in different Figures denote similar components.

### DETAILED DESCRIPTION

Generally stated, the non-limitative illustrative embodiment of the present disclosure provides a method and system for the authentication of hologram protected identity (ID) documents such as, for example, passports, consular cards or other identity cards. It is to be understood that the disclosed method and system may also be used to authenticate other types of documents that include a hologram security element.

In an airport, for example, the verification of an ID document is performed by an accredited person that physically takes the ID document and manipulates it as needed to validate the different security elements that must be present. The number of security elements varies depending on the degree of confidence that is required with regard to the identity of the person and the validity of the ID document. When the authentication of the ID document is performed remotely, the tactile aspect of any security element is not available. As for the visual inspection, it can be performed only with the use of a camera that is managed by the end-user. Current smartphones and tablets are good candidates for use in this context as they enable the capture of photos as well as videos.

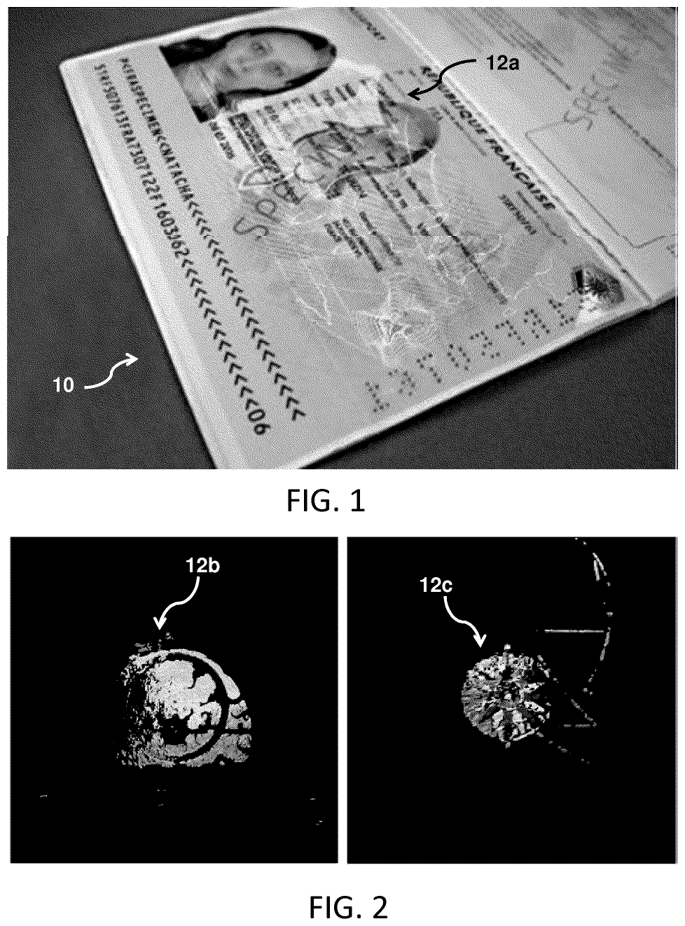

The disclosed method and system for the authentication of hologram protected ID documents addresses the problem of the authentication of ID documents rather than person authentication. It is less the person who carries out a transaction that requires authentication than the ID document that is produced to validate the person's identity. Referring to FIG. 1, there is shown an example of a French passport 10 where a part of a security element in the form of a hologram 12a is visible. Holograms are elements added in ID documents, or other official documents, because the production of such elements in a document is very specific. By the nature itself of such an element, the aspect of a hologram changes according to the viewpoint of the viewer. Consequently, a simple photo of a document is not sufficient to test the presence of the complete hologram. From each viewpoint, only parts of the hologram are visible. In a remote context, authentication is based on images provided by the end-user. Accordingly, the aim of the present method and system is to reconstitute the largest part of the hologram, taking into consideration that in some cases the hologram may be superimposed on another image, viewed according to the viewing angle.

In the context of a controlled setting, for example a customs counter at a border crossing or airport, the authentication of hologram protected ID documents is based on the use of specific lighting, for example a set of fixed well positioned LEDs of specific wavelengths, with the ID document being moved and manipulated in a specific way by experienced personnel. Of course, such solutions cannot be used in the case of remote authentication or authentication by non-experienced personnel. End-users have no specialized light sources; they cannot be asked to use several LEDs in a sophisticated manner or use a specific authentication protocol. The end-users usually have access only to non-specialized cameras which, nowadays, are mostly provided on smartphones or tablets. Such cameras provide functionalities such as still images and videos with or without a light/flash.

Existing commercial solutions focus on small holograms embedded in cards or notes. These solutions often take advantage of the a priori size and the precise position of the hologram in the document to be authenticated and rely on traditional image processing techniques with or without supervised learning phases. The present method and system for the authentication of hologram protected ID documents deal with documents that include very large and diverse holograms on parts of the whole of its surface. Thus, the authentication process also includes detection of the hologram security element. Accordingly, the disclose method and system allows for simultaneous detection and extraction of all the content of a hologram, taking advantage of the partial presence of the hologram depending on the point of view considered in successive images of a video of the ID document.

### Single Image Analysis

Looking at a hologram protected ID document, for example a passport or an image of a passport, the human eye does not see the entire hologram embedded in the document. Nevertheless, on a single image some parts of the hologram are visible. Firstly, the focus is on the detection of hologram parts on a single image, before addressing the complete hologram and concluding on the presence of a hologram. Furthermore, an analysis is performed at the pixel level before local and global approaches. A selection of pixels is carried out using a color histogram analysis, leading to hologram parts candidates, then the connected component of such pixels is analyzed both from their shapes and colors properties.

### Pixel Level

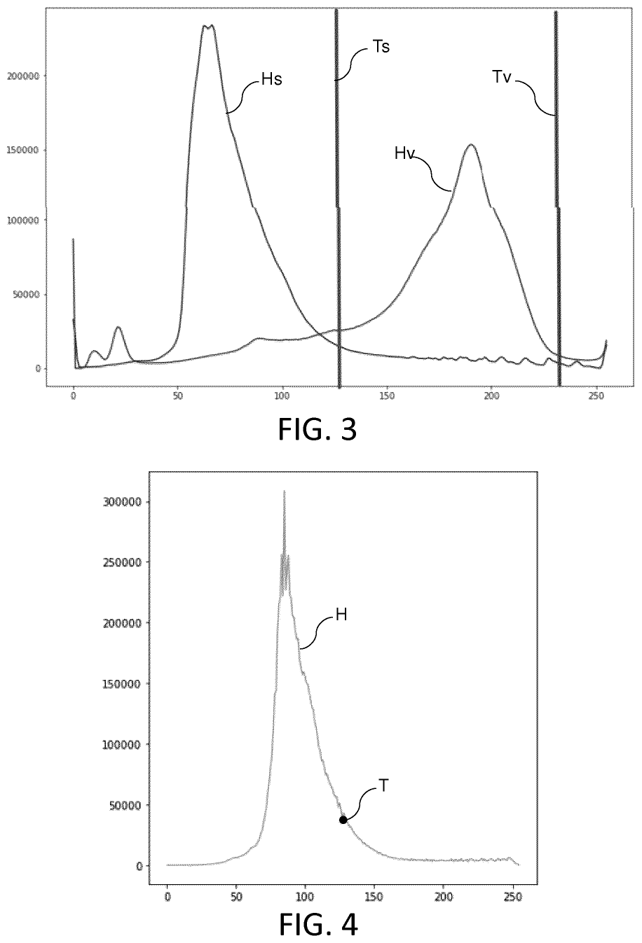

In this first part of the process, the aim is not to exactly identify the hologram pixels but to exploit general properties of such pixels, without missing too much true visible hologram pixels, and introducing too much false hologram pixels. Referring to FIG. 2, when looking at a hologram 12b, 12c it is apparent that the colors are flashy colors; then, pixels with high values can be considered in one of the three colors highlighted in the RGB color space. But these three colors have no specificity with respect to a hologram presence. All hues are equally concerned in hologram and whatever the colors are, a hologram contains a wide variety of hues. Accordingly, the hologram pixels color and hue are not so important, but saturation and value are the most important elements to consider in order to characterize hologram pixels. Based on this observation, the usual RGB color space is not the most suited for the study and alternatively the HSV color space can be used. A pixel P of spatial coordinates (x,y) will be characterized in a two-dimensional space (cs, cv) considering, respectively, the saturation and value of the pixel expressed in the HSV space. The potential hologram pixels are those with high saturation(S) and value (V), thresholds have to be chosen and, of course, have to be adapted to each image content and illumination context. These thresholds are considered as global to an image. They are computed using the analysis of two histograms, the saturation and value pixel histograms. In the image, the part of the hologram that is visible in natural illumination is very small with respect to the image domain, then the presence of such pixels is not materialized by a peak in the histogram as can be seen in FIG. 3 where histogram of saturation Hs and value Hv of pixels in an image are built. The values of the best thresholds manually fixed, designed by the Ts and Tv vertical lines are not associated with a very significant valley or peak in the histogram curve Hs, Hv.

The threshold for one image is fixed so that the maximum number of hologram pixels is obtained. It is chosen at a minimum of the histogram, the significant minimum higher than the mean value of the histogram or more precisely the first maximum after the mean value to limit the number of false positive hologram pixels. The significance of the minimum and maximum are measured using morphological operations. The position of such a threshold is indicated by the dot T on the histogram H of FIG. 4.

The same process is applied on the saturation and value channels leading to two thresholds Ts and Tv. The retained pixels in an image I are those for which the two constraints are holding. They constitute a set M defined as:

$$M = \{ P ( x , y ) ∈ I \vert {c}_{s} > {T}_{s} and {c}_{v} > {T}_{v} \} \qquad Equation 1$$

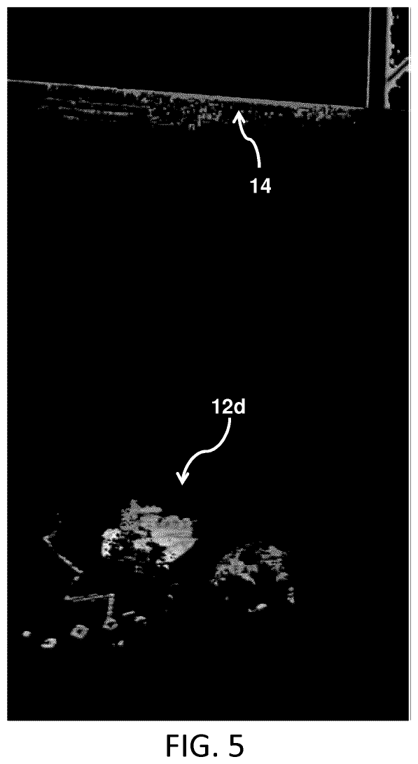

A white high luminance zone is not selected in M as a potential hologram; indeed, the saturation in such zone is not high enough to be selected in the thresholding phase. This can be seen in FIG. 5 where light coming from a bright white screen 14 turned on in the top of the image is not selected as hologram 12d pixels, only the contour of the screen 14 is selected, and it will be easy to eliminate them in a second phase.

Of course, as already indicated, in M are some false hologram pixels and the next objective is to eliminate them as they are considered as noise, nevertheless true hologram pixels must be preserved.

### Local Level

To achieve this, a more local approach is considered. In M each connected component is studied independently. Two aspects are considered, on the one hand, the shape of the candidate zones is analyzed and on the other hand, the hues of the components are analyzed. More specifically, the behavior of M and a dilation of M are compared using a square structuring element of radius 1, the result of the dilation will be a set noted Md.

### Shape Analysis

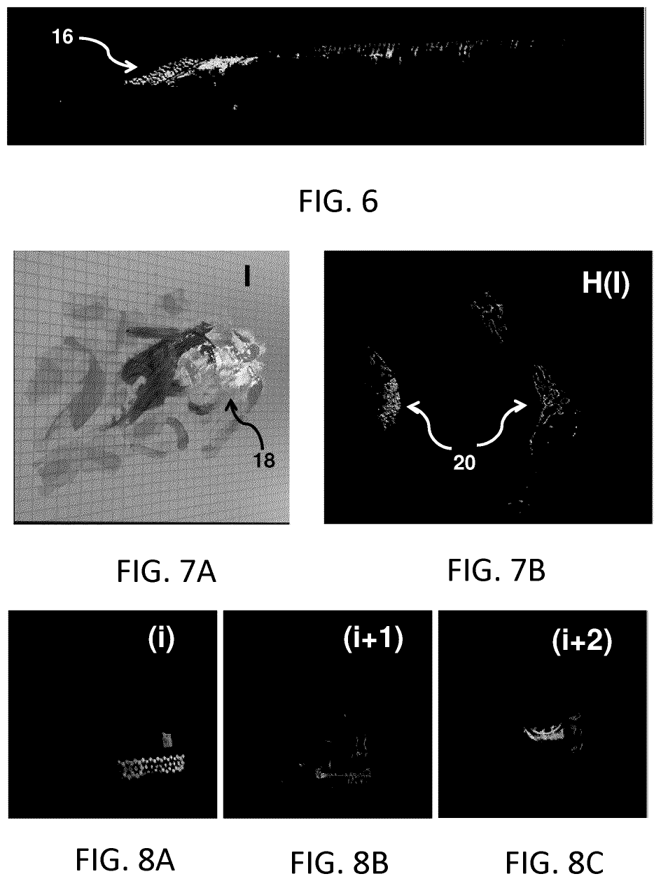

The aim is to characterize zones in M according to their texture in zones different from line drawings or flat zones. It can be noticed that when a hologram zone is concerned, the edges of the zone are quite smooth whereas when some glint is present, the zone is not so coherent and appears most often as blobs that are near one from the other but spread on the zone. This effect can be seen in FIG. 6, where some non-hologram pixels 16 are shown, they are associated with a glint in the initial image and represent a pixel zone having a porous structure figured by small neighboring components. We want to detect such pixels and eliminate them from M.

Due to the porous aspect in some parts of M, the connected components of M are not all significant with respect of the extraction of a hologram. Md has been built in order to consider a smaller number of connected components and we consider the connected components of Md. The connected components in M are embedded in one of the connected components of Md:

$${M}_{d} = {⋃}_{i = 1}^{N} {C}_{i} \qquad Equation 2$$

The analysis is done for each connected component Ci in Md. This local observation level is a good comprise between the pixel study and a global study. The zones that are looked for in M are zones that appear quite porous. In that case, the connected components in M, thanks to the dilation become connected in Md.

This evolution is measured by the number of connected components in M included in one component of Md. Each time the number of connected components of M in Ci is too high, it can be concluded the Ci part is porous and cannot be considered as a potential hologram zone. So, it will be suppressed from M. The suppressed part Ss in M is obtained from the study of all connected components of Md:

$${S}_{s} = ⋃ \{ {C}_{i} ⋂ M \vert T ( {C}_{i} ⋂ M ) \geq {n}_{0} for i = 1 to N \} \qquad Equation 3$$

where T(X) is the number of connected components in X and no is a constant that has been fixed during training, using a set of training images.

### Color Analysis

Another characteristic of the holograms is the distribution of hues that distinguishes a hologram from any glittering surface. Globally, but also locally, the number of hues contained in a hologram is high whereas a glint has generally an only global color. So, locally, on each part of M limited by a connected component of Md, the number of hues is computed and normalized according to the size of the component evaluated. Here, we consider the area as the size of the component. This enables to define a set of pixels Sc that can be assumed not to be in a hologram:

$${S}_{s} = ⋃ \{ {C}_{i} ⋂ M \vert \frac{C ( {C}_{i} ⋂ M )}{\vert {C}_{i} ⋂ M \vert} \leq c for i = 1 to N \} \qquad Equation 4$$

where C(X) gives the number of different hues contained in a set X of pixels, |X| gives the area of X and c is a constant that has been fixed during training, using a set of training images.

At this stage of the process, in the image I, the hologram pixels extracted H(I) are those with high saturation and value but that do not form a porous region and are locally with several hues:

$$H ( I ) = M ( {S}_{s} ⋃ {S}_{c} ) \qquad Equation 5$$

Of course, H(I) should be empty if the image I does not contain a hologram, this happens most often but some images can contain pixels that are selected in the process of a single image. The case is illustrated in FIGS. 7A and 7B where an image I does not contain any hologram but has some varnished products 18 superimposed thereon (FIG. 7A) resulting in H(I) having selected pixels 20 (shown zoomed in) associated with the white part (varnished area 18) on the right part of I (FIG. 7B).

This last example shows that the study of a single image is not enough to extract with high confidence only hologram pixels. Then, at least two images are necessary to decide whether a document contains or not a hologram. Furthermore, to extract and reconstruct the hologram, it is necessary to analyze a larger number of images acquired from several points of view so that each part can be aggregated to reconstitute the hologram. A video can be used to that end, the video being obtained by the end-user using a smartphone or tablet camera.

### Video Analysis

The main objective of the present method and system is to authenticate ID documents thanks to the presence of a true hologram. This can be done in two steps, first the document must contain a hologram and this hologram must be a true one. Passports, consular cards or other identity cards of different countries do not contain the same hologram. First, the method and system for the authentication of hologram protected ID documents assert if a document D contains or not a hologram. A video can be considered as a series of images (li) Then, i=1 the extraction of the potential hologram will be performed thanks to the study of each frame of the video.

### Two Images Analysis

When looking at a hologram, the visual aspect of the image varies according to the angle between the document surface's orthogonal axis and the axis of view of the camera. This can be observed in FIGS. 8A, 8B and 8C where there are displayed the results of the single image analysis process, applied to three adjacent frames in a video, i.e., (i) (FIG. 8A), (i+1) (FIG. 8B) and (i+2) (FIG. 8C). In a video of a document without any hologram, the elements mistaken in H(I) as part of a potential hologram are seen in the same way in all the frames of the video and the difference visible in H(Ii), H(Ii+1) is just linked to a change in perspective in the two frames. The present method and system for the authentication of hologram protected ID documents rely on the computation of the difference between the contents of the different H(Ii). The difference measure is computed as:

$$d ( H ( {I}_{i} ) , H ( {I}_{j} ) ) = \frac{1}{\vert H ( {I}_{i} ) ⋃ H ( {I}_{j} ) \vert} {\sum }_{P ∈ H ( {I}_{i} ) ⋃ H ( {I}_{j} )} {‖ {I}_{i} ( P ) - {I}_{j} ( P ) ‖}^{2} \qquad Equation 6$$

where |X| indicates the cardinal of a set X. Here the difference between the color features of P pixels that are used is linked to the usual Euclidean norm in the RGB space. The highest d (H(Ii) is, the highest the probability that the document contains a true hologram.

To emphasize the difference between documents with and without a hologram, this computation can be done on all pairs of consecutive frames or considering a set J of pairs of distant frames. Then, the score of a document D is defined as:

$$Score ( D ) = \frac{1}{\vert J \vert} {\sum }_{( i , j ) ∈ J} d ( H ( {I}_{i} ) , H ( {I}_{j} ) ) \qquad Equation 7$$

where |X| indicates the cardinal of a set X. When a hologram is present, the score must be high. In order to make a decision, a threshold has to be fixed according to a representative training set. The threshold depends on the number and nature of frame pairs involved in the computation of the score.

In case of a positive presence of a hologram in the document, it is possible to rebuild the hologram or part of the hologram from the study of each frame.

### Hologram Extraction

On each frame I of the video some part of the hologram is detected, extracted and associated with H(I). Nevertheless, it is not sufficient to consider the union of the H(Ii). For example, the document may be held by the end-user in a non-stable position, or the camera is held in hand and is mobile with respect to the document, or both the document and the camera are moving. Before the aggregation of the different parts, a registration process is performed between consecutive frames or, depending on the acquisition protocol, all frames can be registered on a single frame of the video. Let RI note the transform of frame I during the registration with a fixed frame of the video. Then the hologram of the document can be recovered by following process:

$${⋃}_{i = 1}^{T} {R}_{{I}_{i}} ( H ( {I}_{i} ) ) \qquad Equation 8$$

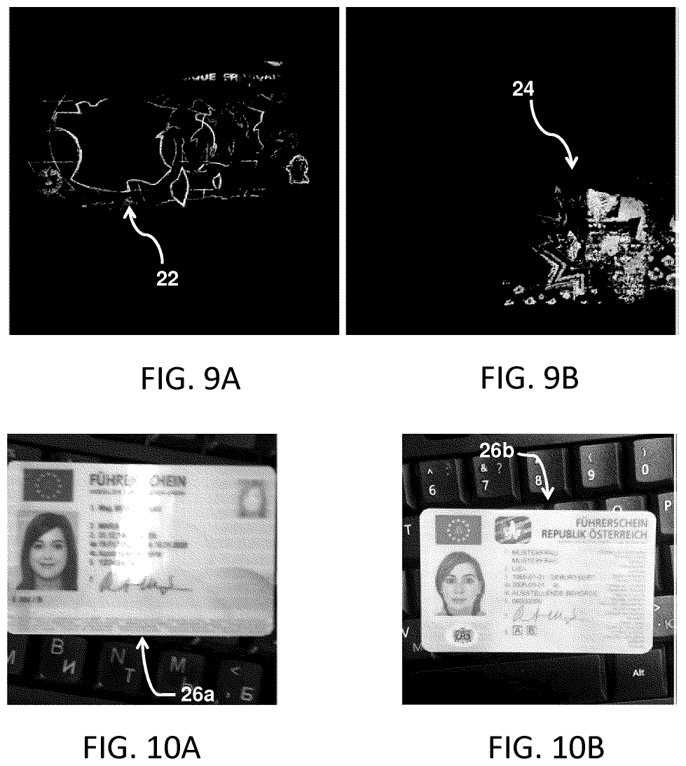

Referring to FIGS. 9A and 9B, there is shown the extraction of holograms 22, 24 from a French passport (FIG. 9A) and a Canadian one (FIG. 9B), respectively. All the pixels in the holograms are not recovered, but enough is extracted so that the origins of the documents can be deduced. The omitted parts are linked to the way the videos are acquired. This is due to the length of the videos being too short to make all parts of the holograms visible in normal light. Furthermore, some parts can be seen as blurred when two different figures of the hologram are superimposed.

### Training

The method and system for the authentication of hologram protected ID documents are suited for any type of document containing a hologram with no a priori information about the presence or not of a hologram.

The thresholds and constants can be set by performing the on a training set of videos of true passports of various nationalities, for example a set of 37 such videos, and on a set of videos of documents 26a, 26b without a hologram (see FIGS. 10A and 10B), which may be taken from, for example, public video database MIDV500 of identity documents. In this database, images of true identity documents have been printed and coated with plastic. These documents do not contain any true holograms.

For each video of the database, the aim is to determine whether the document contains or not a hologram. The evaluation is then performed with respect to precision, recall and F1-measure. Precision evaluates how false documents have been authenticated, recall evaluates how true documents have not been authenticated and F1-measure gives the harmonic mean of the previous two. Table °1 gathers together the three values.

TABLE 1
Evaluation of the method

| precision | recall | F1-measure |
|---|---|---|
| 97.22 | 92.11 | 94.60 |

The values in Table °1 mean only one of the holograms in the 37 videos containing one has not been detected. In this case the distance (during acquisition) between the camera and the document being too large explains the results. Some registration at detection level would be needed. The false positives are linked with the instability of the acquisition mode of the different videos. To improve such false positives, as well as for false negatives a registration could be used in the detection phase.

The confidence on the presence of the hologram is linked to the score value that is computed in Equation (7) and more precisely on the position of the score value and the threshold. It can be observed that the confidence is larger when the acquisition is performed with a distance between the document and the camera is rather small.

The method and system for the authentication of hologram protected ID documents allow the detection of a hologram remotely via images of the document acquired with a common smartphone or tablet and light. The acquisition is then possible by the end-user. As single image is not optimal for the method and system to provide a precise conclusion, a video is advantageously used with a relative movement between the document and the camera.

In an alternative embodiment, the retrieval of the hologram manages the different superimposed elements. Continuity in the appearance of the pattern can help to discriminate between the multi shape of the hologram. Furthermore, from the hologram extracted some recognition of the identity document can be achieved and thus confirm the authentication of the document.

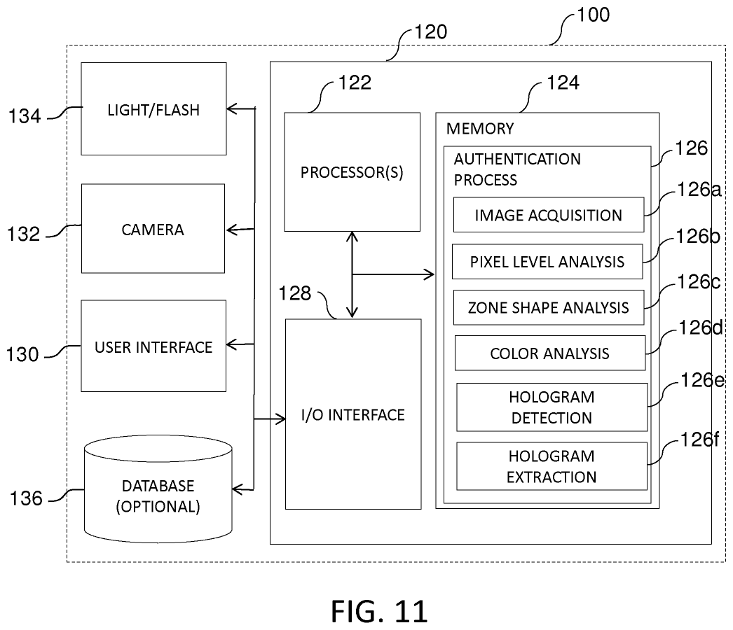

Referring to FIG. 11, the system for the authentication of hologram protected ID documents 100 includes a processing unit 120 having one or more processor 122 with an associated memory 124 having stored therein processor executable instructions 126 for configuring the one or more processor 122 to execute image acquisition 126a, pixel level analysis 126b, zone shape analysis 126c, color analysis 126d, hologram detection 126e and hologram extraction 126f processes. It is to be understood that other processes, libraries and tools executable instructions may be stored in the memory 124 in order to support processes 126a, 126b, 126c, 126d and 126f. The processing unit 120 further includes an input/output (I/O) interface 128 for communication with a user interface 130, a camera 132, a light/flash 134 and an optional database 136. The system for the authentication of hologram protected ID documents 100 may be built specifically for the purpose of the authentication of hologram protected ID documents or may be implemented as an application downloadable onto a smartphone or tablet.

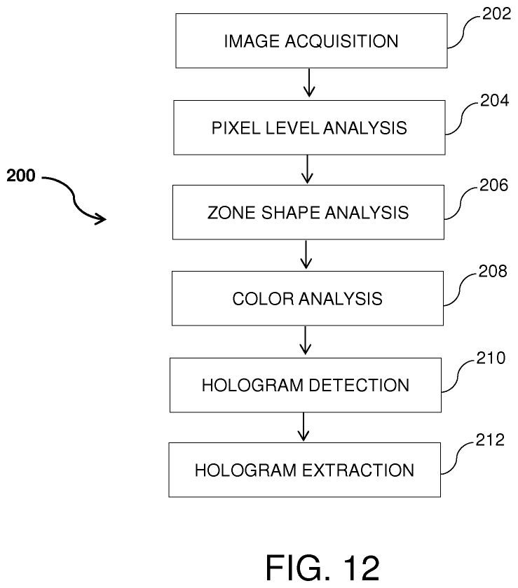

Referring now to FIG. 12, there is shown a flow diagram of the method for the authentication of hologram protected ID documents 200 in accordance with the illustrative embodiment of the present disclosure. Steps of the method 200 are indicated by blocks 202 to 212.

The process 200 starts at block 202 where an image of the ID document is acquired, advantageously 2 or more images. Alternatively, a video can be acquired and a series of two or more images extracted from the video frames. The image and video acquisition can be performed using, for example, camera 132 of the system for the authentication of hologram protected ID documents 100 of FIG. 11.

At block 204, the process 200 performs a pixel level analysis, identifying in each acquired image pixels whose saturation and value are both above associate thresholds determined from respective saturation and value histograms. To facilitate these computations, each image may optionally be expressed in the HSV colors space instead of the RGB color space.

Then, at block 206, the process 200 performs a zone shape analysis for all pixels identified at block 204. This is done in order to identify pixel zones having a porous structure figured by small neighboring components and eliminate pixels from such zones as they do not belong to a hologram. This is performed by building a set M of connected components from the pixels identified at block 204 and a set Md of connected components from a dilation of M. Each time the number of connected components of M in a single connected component of Md is above a specified value, it can be concluded this connected component of Md is porous and cannot be considered as a potential hologram zone. So, it will be suppressed from M. The specified value can be fixed using a set of training images.

At block 208, the process 200 performs a color analysis by computing the number of hues present in each remaining connected components of M from block 206 and normalizing the result according to the size of the connected component evaluated. If the normalized number of hues is below a specified value, it can be concluded this connected component cannot be considered as a potential hologram zone. So, it will be suppressed from M. The specified value can be fixed using a set of training images.

At block 210, the process 200 performs the hologram identification. At this stage, the remaining extracted pixels are those with high saturation and value but that do not form a porous region and are locally with several hues. In order to identify a hologram, the difference between the color features of the remaining extracted pixels of different images is computed. The highest the difference is, the highest the probability that the document contains a true hologram. To emphasize the difference between documents with and without a hologram, this computation can be done on all pairs of consecutive frames of a video or considering a set of pairs of distant frames. Then, the score of a document is defined as the average of all the computed differences. When a hologram is present, the score must be high. In order to make a decision, a threshold has to be fixed according to a representative training set. The threshold depends on the number and nature of frame pairs involved in the computation of the score.

Finally, at block 212, the process 200 performs the hologram identification. The hologram of the document can be recovered by aggregating the remaining extracted pixels of each image. However, before the aggregation, a registration process is performed between consecutive frames or, depending on the acquisition protocol, all frames can be registered on a single frame of the video. Let RI note the transform of a given frame I during the registration with a fixed frame of the video. Then the hologram of the document can be recovered by aggregating the remaining extracted pixels of each image I to which is applied the corresponding transform RI.

Although the present disclosure has been described by way of particular non-limiting illustrative embodiments and examples thereof, it should be noted that it will be apparent to persons skilled in the art that modifications may be applied to the present particular embodiment without departing from the scope of the present disclosure as hereinafter claimed.

What is claimed is:

1. A method for the authentication of a hologram protected document, the method comprising the steps of:
a) obtaining at least two images of the document;
b) identifying in each of the at least two images pixels having a saturation and a value above respective saturation and value threshold;
c) building a set of identified pixels connected components from the identified pixels of step b) for each of the least two images;
d) removing from the set of identified pixels connected components any connected components belonging to a porous structure;
e) computing a number of hues present in each remaining connected component of the set of identified pixels connected components and normalizing the number of hues according to a size of each of the remaining connected component from the set of identified pixels connected components;
f) removing from the remaining connected components of the set of identified pixels connected components any connected component associated with a normalized number of hues below a specified hue number value;
g) determining the presence of a hologram by computing a difference between color features of the remaining connected components of the set of identified pixels connected components of different images of the at least two images;
h) setting a document score by computing an average of all the computed differences;
i) authenticating the hologram protected document when the document score is above a specified document score value.

2. A method for the authentication of a hologram protected document according to claim 1, wherein the document is an identity document.

3. A method for the authentication of a hologram protected document according to claim 2, wherein the identity document is selected from a group consisting of a passport and a consular card.

4. A method for the authentication of a hologram protected document according to any one of claims 1 to 3, wherein at step b) the saturation threshold and the value threshold are determined from respective saturation and value histograms.

5. A method for the authentication of a hologram protected document according to claim 4, wherein the saturation threshold and the value threshold are determined by choosing a significant minimum higher than the mean value of the corresponding saturation and value histograms.

6. A method for the authentication of a hologram protected document according to any one of claims 1 to 5, wherein step a) includes expressing the at least two images in the HSV colors space.

7. A method for the authentication of a hologram protected document according to any one of claims 1 to 6, wherein step d) includes for each of the at least two images:
obtaining a dilated set of connected components by applying dilation to the set of identified pixels connected components;
each time a number of connected components of the set of identified pixels connected components present in a given connected component of the dilated set of connected components is above a specified connection number value, removing pixels of the given connected component of the dilated set of connected components from the set of identified pixels connected components.

8. A method for the authentication of a hologram protected document according to claim 7, wherein the specified connection number value at step d) is determined using a set of training images.

9. A method for the authentication of a hologram protected document according to claim 1, wherein the specified hue number value at step f) is determined using a set of training images.

10. A method for the authentication of a hologram protected document according to claim 1, wherein the specified document score value at step i) is determined using a set of training images.

11. A method for the authentication of a hologram protected document according to any one of claims 1 to 10, wherein at step a) the at least two images are obtained by extracting frames from a video of the document.

12. A method for the authentication of a hologram protected document according to claim 11, wherein step g) if performed for all pairs of consecutive frames of the video.

13. A method for the authentication of a hologram protected document according to claim 11, wherein step g) if performed for pairs of distant frames of the video.

14. A method for the authentication of a hologram protected document according to any one of claims 11 to 13, further comprising the step of:
j) recovering the hologram by aggregating pixels of the remaining connected components of the set of identified pixels connected components of each of the at least two images to which is applied an associated frame transform.

15. A method for the authentication of a hologram protected document according to claim 14, wherein a step j) the associated frame transform is a transform of a video frame corresponding to each of the at least two images during fixed frame registration.

16. A method for the authentication of a hologram protected document according to any one of claims 1 to 15, wherein the steps are in the form of executable code for execution by a processor of a smartphone or tablet.

17. A system for the authentication of a hologram protected document, the system comprising:
a camera;
at least one processor operatively connected to the camera, the at least one processor having an associated memory having stored therein processor executable code that when executed by the at least one processor performs the steps of:
a) obtaining at least two images of the document from the camera;
b) identifying in each of the at least two images pixels having a saturation and a value above respective saturation and value threshold;
c) building a set of identified pixels connected components from the identified pixels of step b) for each of the least two images;
d) removing from the set of identified pixels connected components any connected components belonging to a porous structure;
e) computing a number of hues present in each remaining connected component of the set of identified pixels connected components and normalizing the number of hues according to a size of each of the remaining connected component from the set of identified pixels connected components;
f) removing from the remaining connected components of the set of identified pixels connected components any connected component associated with a normalized number of hues below a specified hue number value;
g) determining the presence of a hologram by computing a difference between color features of the remaining connected components of the set of identified pixels connected components of different images of the at least two images;
h) setting a document score by computing an average of all the computed differences;
i) authenticating the hologram protected document when the document score is above a specified document score value.

18. A system for the authentication of a hologram protected document according to claim 17, wherein the document is an identity document.

19. A system for the authentication of a hologram protected document according to claim 18, wherein the identity document is selected from a group consisting of a passport and a consular card.

20. A system for the authentication of a hologram protected document according to any one of claims 17 to 19, wherein at step b) the saturation threshold and the value threshold are determined from respective saturation and value histograms.

21. A system for the authentication of a hologram protected document according to claim 20, wherein the saturation threshold and the value threshold are determined by choosing a significant minimum higher than the mean value of the corresponding saturation and value histograms.

22. A system for the authentication of a hologram protected document according to any one of claims 17 to 21, wherein step a) includes expressing the at least two images in the HSV colors space.

23. A system for the authentication of a hologram protected document according to any one of claims 1 to 22, wherein step d) includes for each of the at least two images:
obtaining a dilated set of connected components by applying dilation to the set of identified pixels connected components;
each time a number of connected components of the set of identified pixels connected components present in a given connected component of the dilated set of connected components is above a specified connection number value, removing pixels of the given connected component of the dilated set of connected components from the set of identified pixels connected components.

24. A system for the authentication of a hologram protected document according to claim 23, wherein the specified connection number value at step d) is determined using a set of training images.

25. A system for the authentication of a hologram protected document according to claim 17, wherein the specified hue number value at step f) is determined using a set of training images.

26. A system for the authentication of a hologram protected document according to claim 17, wherein the specified document score value at step i) is determined using a set of training images.

27. A system for the authentication of a hologram protected document according to any one of claims 17 to 26, wherein in step a) the at least two images are obtained by extracting frames from a video of the document obtained by the camera.

28. A system for the authentication of a hologram protected document according to claim 27, wherein step g) if performed for all pairs of consecutive frames of the video.

29. A system for the authentication of a hologram protected document according to claim 27, wherein step g) if performed for pairs of distant frames of the video.

30. A system for the authentication of a hologram protected document according to any one of claims 27 to 29, further comprising the step of:
j) recovering the hologram by aggregating pixels of the remaining connected components of the set of identified pixels connected components of each of the at least two images to which is applied an associated frame transform.

31. A system for the authentication of a hologram protected document according to claim 30, wherein a step j) the associated frame transform is a transform of a video frame corresponding to each of the at least two images during fixed frame registration.

32. A system for the authentication of a hologram protected document according to any one of claims 17 to 32, wherein the camera and the at least one processor are provided by a smartphone or a tablet.
